(19) United States
(12) Patent Application Publication
(10) Pub. No.: US 2026/0369187 A1
(43) Pub. Date: Nov. 19, 2026

(54) Signboard

(71) Applicant: Tomoto Adachi, Sendai-City (JP)

(72) Inventors: Tomoto Adachi, Sendai-city (JP); Atuko Shirade, Sendai-city (JP)

(21) Appl. No.: 19/728,410

(22) Filed: Jul. 2, 2026

Related U.S. Application Data
(63) Continuation of application No. PCT/JP2024/044842, filed on Dec. 18, 2024.

(30) Foreign Application Priority Data
Jan. 4, 2024 (JP) 2024-008342

(51) Int. Cl. G09F 7/18

(52) U.S. Cl. CPC G09F 7/18; G09F 2007/1852

(57) ABSTRACT

A rubber magnet bonded to an opposite side of a sign surface of a sign member and a rubber magnet disposed via an adhesive layer provided in a portion of a curb are joined by magnetic force. A first joining member includes a base embedded in an adhesive layer; and a female screw provided inside a column integrally provided in the base. A second joining member includes a male screw; a through hole on a side opposite to a side on which the male screw is provided; and a locking pin. To prevent the sign member and the rubber magnet on a curb side from separating, the first joining member and the second joining member are disposed in a through hole communicating with the sign member and the rubber magnets on a sign member side and the curb side, and the female screw and the male screw are screwed together.

### CROSS-REFERENCE TO RELATED APPLICATIONS

This application is a bypass continuation of International Patent Application No. PCT/JP2024/044842 filed Dec. 18, 2024, and claims priority to Japanese Patent Application No. 2024-008342 filed Jan. 4, 2024 the disclosures of which are hereby incorporated by reference in their entireties.

### BACKGROUND OF THE INVENTION

### Field of the Invention

The present invention relates to a signboard installed on a curb, and more particularly to a signboard having a configuration in which a sign portion formed of a reflector is attachable to and detachable from an installation surface.

### Description of Related Art

Signboards include standing signboards and placed signboard, and indicate information such as public awareness, guidance and attention during construction, and advertisement.

In a case where such a standing signboard or a placed signboard is installed, the area occupied on a road increases and measures for ensuring public safety are also needed. Attaching weights for preventing scattering due to bad weather is one example of the measures. In addition, in a case where a reflector is directly bonded with an adhesive or the like or painted, the bonding or the painting is based on the idea of simply obtaining visibility, and other methods are not considered.

As one of solutions to such a situation, JP 2005-273266 A discloses that a reflector is directly bonded to an upper portion of a curb with an adhesive or the like to alert pedestrians and the like to danger. JP 2005-273266 A discloses a curb stud installed around a road to facilitate visual guidance for drivers and clarification of road linearity, the curb stud including a retroreflector and a transparent resin layer containing a luminous pigment and being provided on an outer surface of the retroreflector.

However, although the curb stud disclosed therein can be easily bonded to a curb with an adhesive, there is a problem to be considered. The problem is that a curb cut in the curb comes in various shapes, it is difficult to bond the curb stud with an adhesive, a location to which the curb stud is bonded is limited to a flat surface or the like such as an upper surface of the curb, and when the curb stud is partially damaged, the entire curb stud needs to be replaced, and cost increases.

### SUMMARY OF THE INVENTION

In view of the above problem, an object of the present invention is to provide a signboard which has fewer restrictions on a position for bonding to a curb and in which only a portion that is frequently damaged is easily replaceable.

In order to solve the above problem, the present inventors have made the present invention as a result of intensive studies on a structure of a signboard and a method of attaching the signboard to a curb.

A signboard according to one aspect of the present invention to solve the above problem includes: a sign member including a sign surface portion that indicates needed information by a reflector, the sign member including a first sheet-form rubber magnet layer bonded to a surface opposite to the sign surface portion; and a joining unit for the sign member, the joining unit being provided on at least one of a side surface of a curb including at least a curb cut portion and an upper surface of the curb. In the signboard, the joining unit includes: a second sheet-form rubber magnet layer; a first joining unit; a second joining unit; and a locking pin. The second sheet-form rubber magnet layer is provided on at least one of the side surface of the curb including at least the curb cut portion and the upper surface of the curb, the second sheet-form rubber magnet layer being joined by an adhesive layer. The first joining unit includes: a columnar portion having approximately the same height as the total thickness of the sign member, the first sheet-form rubber magnet layer, and the second sheet-form rubber magnet layer; a base portion formed integrally with the columnar portion, the base portion having an area greater than the area of the columnar portion, the base portion having a height approximately the same as a thickness of the adhesive layer; and a female screw provided in the columnar portion, the columnar portion being disposed in a through hole communicating with the sign member and the second sheet-form rubber magnet layer, the base portion being embedded in the adhesive layer. The second joining unit includes: a male screw to be screwed into the female screw of the first joining unit; and a through hole in a portion exposed without being screwed into the female screw. The locking pin has a generally E-shape, the locking pin having a configuration in which a central protrusion penetrates the through hole.

In addition, in the signboard according to the one aspect of the present invention, the first sheet-form rubber magnet layer has a thickness of 0.8 to 2.8 mm, the second sheet-form rubber magnet layer has a thickness of 3.0 to 5.0 mm, and the adhesive layer has a thickness of 0.8 to 1.0 mm.

In addition, in the signboard according to the one aspect of the present invention, recesses and protrusions that are engaged with each other are formed on opposing surfaces of the first sheet-form rubber magnet layer and the second sheet-form rubber magnet layer.

The signboard according to the present invention includes the joining unit for joining the sign surface portion that indicates predetermined information on the signboard in an attachable and detachable manner. The joining unit can be disposed according to a shape of at least one of the side surface including at least the curb cut portion of the curb and the upper surface of the curb. Therefore, the sign surface portion can be easily replaced, and the area occupied by the signboard itself in a road space can be reduced. It is important that the sign surface portion is replaceable also from the viewpoint of use in an environment where the sign surface portion is easily damaged, such as on a road curb.

In addition, in the signboard according to the present invention, it is also possible to provide recesses and protrusions that are engaged with each other on the joining surface side of a sheet-form rubber magnet constituting the joining unit, and accordingly it is possible to prevent misalignment between the joining surfaces.

### BRIEF DESCRIPTION OF THE DRAWINGS

FIG. 1 is a perspective view illustrating an example of a signboard according to the present invention, the signboard being attached to a slope of a curb.

FIG. 2 is a view illustrating details of an example of a cross section of a sign member of the present invention.

FIGS. 3A and 3B are views illustrating an example of a first joining unit, FIG. 3A is a plan view, and FIG. 3B is a front cross-sectional view.

FIGS. 4A and 4B are views illustrating an example of a second joining unit, FIG. 4A is a plan view, and FIG. 4B is a front view.

FIG. 5 is a plan view illustrating an example of an E-shaped locking pin according to the present invention.

FIG. 6 is a perspective view illustrating a state in which the E-shaped locking pin is inserted into a through hole of the second joining unit.

FIGS. 7A and 7B are perspective views illustrating a state in which recesses and protrusions that are engaged with each other are imparted to opposing surfaces of a first sheet-form rubber magnet layer and a second sheet-form rubber magnet layer.

FIG. 8 is a cross-sectional view illustrating an example of a magnetized state of the first sheet-form rubber magnet layer and the second sheet-form rubber magnet layer according to the present invention.

### DESCRIPTION OF THE INVENTION

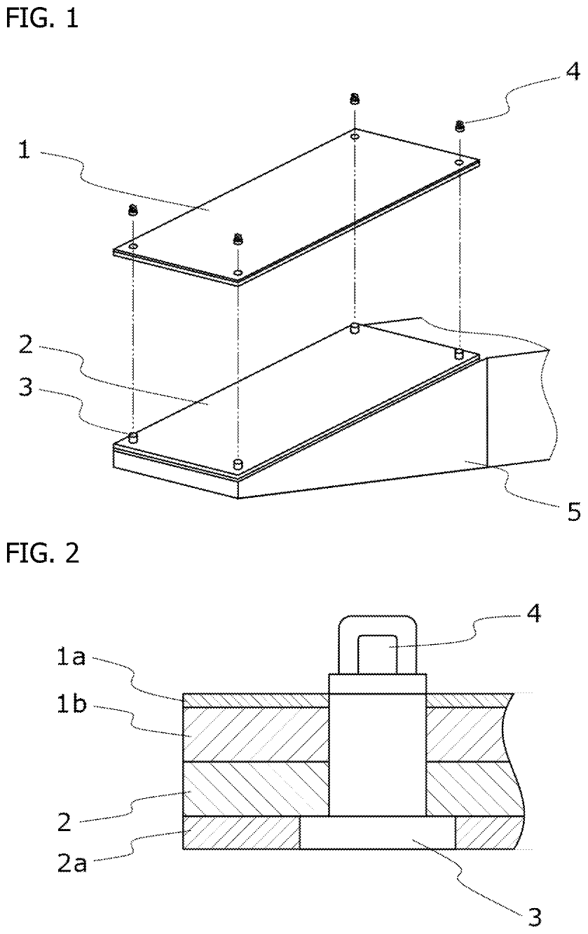

Next, an embodiment of the present invention will be described with reference to specific drawings. FIG. 1 is a perspective view illustrating an example of a signboard according to the present invention, the signboard being attached to a slope of a curb 5, and FIG. 2 is a view illustrating details of an example of a cross section of a sign member 1 according to the present invention.

As illustrated in these figures, the sign member 1 includes a sign surface portion 1a and a first sheet-form rubber magnet layer 1b. The reflection methods of a reflector used for the sign surface portion 1a are retroreflection, diffuse reflection, specular reflection, and the like. For the reflector, it is desirable to use a reflective plate that is widely used for road signs and uses the retroreflection method.

In addition, a second sheet-form rubber magnet layer 2 joined to a surface of the curb 5 by an adhesive layer 2a is used for joining the sign member 1 to the surface of the curb 5. For the first sheet-form rubber magnet layer 1b and the second sheet-form rubber magnet layer 2, a material obtained by dispersing magnet powder in rubber is used, but as a material for the magnet, a ferritic material is desirable from the viewpoint of outdoor durability and cost.

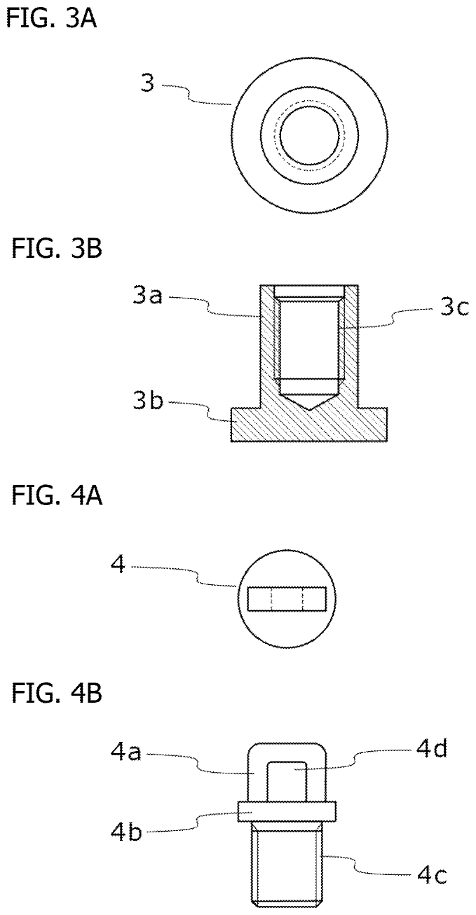

FIGS. 3A and 3B are views illustrating an example of a first joining unit 3 illustrated in FIGS. 1 and 2, FIG. 3A is a plan view, and FIG. 3B is a front cross-sectional view. In addition, FIGS. 4A and 4B are views illustrating an example of a second joining unit 4 similarly illustrated in FIGS. 1 and 2, FIG. 4A is a plan view, and FIG. 4B is a front view.

As illustrated in FIG. 2, a base portion 3b of the first joining unit 3 is disposed so that the base portion 3b is embedded in the adhesive layer 2a. A columnar portion 3a is disposed in a through hole communicating with the sign member 1, which includes the sign surface portion 1a and the first sheet-form rubber magnet layer 1b, and the second sheet-form rubber magnet layer 2. A female screw 3c is provided inside the columnar portion 3a.

The second joining unit 4 is provided with a male screw 4c to be screwed into the female screw 3c of the first joining unit 3, and as illustrated in FIG. 2, an exposed portion 4a and a flange portion 4b are disposed in a state of protruding from the sign surface portion 1a. Although an example in which the flange portion 4b is exposed is illustrated here, the flange portion 4b does not need to be exposed.

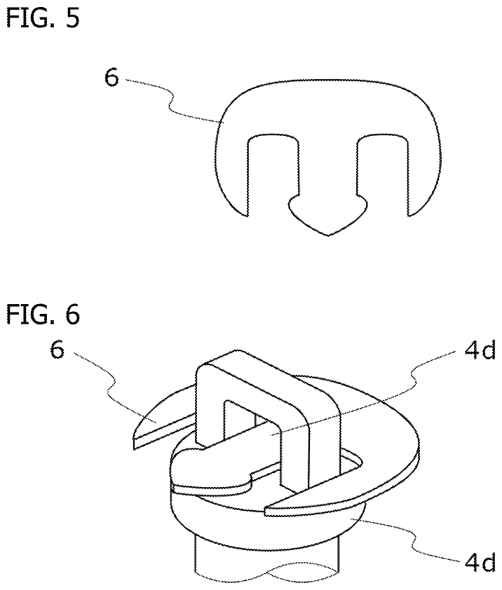

FIG. 5 is a plan view illustrating an example of an E-shaped locking pin 6 according to the present invention. In addition, FIG. 6 is a perspective view illustrating a state in which the E-shaped locking pin 6 is inserted into a through hole 4d of the second joining unit 4. As illustrated here, since the area of a horizontal plane of the E-shaped locking pin 6 is greater than the area of a horizontal plane of the flange portion 4b of the second joining unit 4, it is possible to prevent the sign member 1 from moving upward in the figure and being detached from the surface of the curb 5.

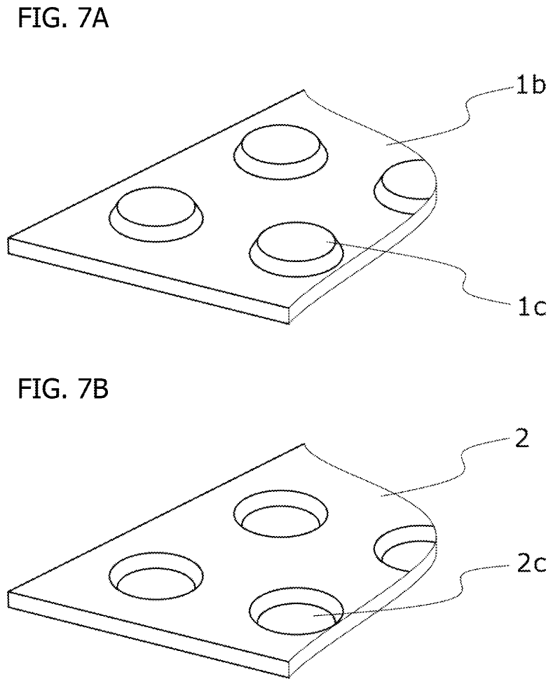

FIGS. 7A and 7B are perspective views illustrating a state in which a protrusion 1c and a recess 2c engaged with each other are formed on opposing surfaces of the first sheet-form rubber magnet layer 1b and the second sheet-form rubber magnet layer 2. In the case of using a rubber magnet, it is not difficult to impart such recesses and protrusions by hot pressing using a mold before a vulcanization process, and it is possible to suppress misalignment between the first sheet-form rubber magnet layer 1b and the second sheet-form rubber magnet layer 2 by engagement between the recesses and protrusions. Note that in the present invention, the thickness of the first sheet-form rubber magnet layer 1b is set to 0.8 to 2.8 mm, the thickness of the second sheet-form rubber magnet layer 2 is set to 3.0 to 5.0 mm, and the thickness of the adhesive layer 2a is set to 0.8 to 1.0 mm, whereby it is possible to secure sufficient joining force generated by magnetic force and sufficient bonding force.

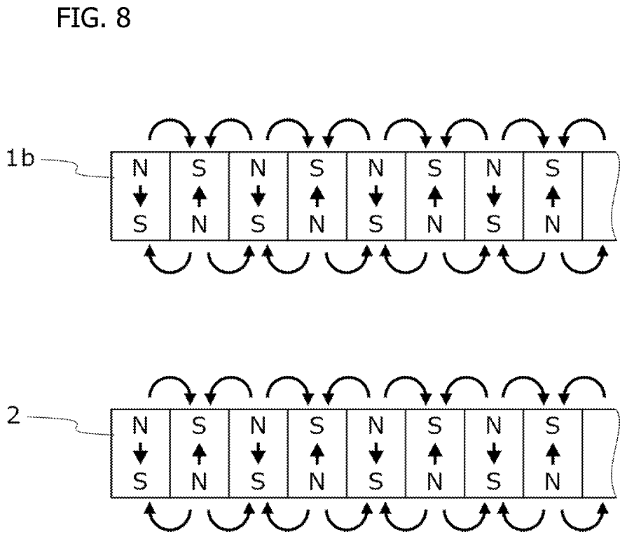

FIG. 8 is a cross-sectional view illustrating an example of a magnetized state of the first sheet-form rubber magnet layer 1b and the second sheet-form rubber magnet layer 2 according to the present invention. The arrows in the figure indicate the directions of magnetic field lines. In the case of a sheet-form magnet, as illustrated here, multipole magnetization in which magnetic poles in a thickness direction reverse at regular intervals is employed, and an N pole and an S pole are opposed to each other, whereby it is possible to enhance joining by magnetic force. In addition, in this case, it is natural that the magnetic force is strengthened more in a case where anisotropy is imparted to the magnet powder to be dispersed into the rubber by orienting the magnet powder in the thickness direction than in a case where isotropy is imparted to the magnet powder.

As described above, the present invention makes it possible to provide a signboard that is attachable to a curb or the like and that has a replaceable sign surface portion. Note that it is natural that the present invention is not limited to the embodiment and even when there are design changes including various modifications and corrections that can be conceived by those having ordinary knowledge in the field of the present invention without departing from the gist of the present invention, the design changes are included in the present invention.

What is claimed is:

1. A signboard comprising:
a sign member comprising a sign surface portion that indicates determined information by a reflector, and a first sheet-form rubber magnet layer bonded to a surface opposite to the sign surface portion; and
a joining unit for the sign member, the joining unit being provided on at least one of a side surface of a curb comprising at least a curb cut portion and an upper surface of the curb, wherein
the joining unit comprises
a second sheet-form rubber magnet layer provided on at least one of the side surface comprising at least the curb cut portion and the upper surface of the curb, the second sheet-form rubber magnet layer being joined by an adhesive layer,
a first joining unit comprising a columnar portion having approximately the same height as the total thickness of the sign member, the first sheet-form rubber magnet layer, and the second sheet-form rubber magnet layer, the first joining unit comprising a base portion formed integrally with the columnar portion, the base portion having an area greater than an area of the columnar portion, the base portion having approximately the same height as a thickness of the adhesive layer, the first joining unit comprising a female screw provided in the columnar portion, the columnar portion being disposed in a through hole communicating with the sign member and the second sheet-form rubber magnet layer, the base portion being embedded in the adhesive layer,
a second joining unit comprising a male screw to be screwed into the female screw of the first joining unit, the second joining unit comprising a through hole in a portion exposed without being screwed into the female screw, and
a locking pin having a generally E-shape, the locking pin having a configuration wherein a central protrusion penetrates the through hole.

2. The signboard according to claim 1, wherein thickness of the first sheet-form rubber magnet layer is 0.8 to 2.8 mm, thickness of the second sheet-form rubber magnet layer is 3.0 to 5.0 mm, and thickness of the adhesive layer is 0.8 to 1.0 mm.

3. The signboard according to claim 1, wherein a recess and a protrusion that are engaged with each other are formed on opposing surfaces of the first sheet-form rubber magnet layer and the second sheet-form rubber magnet layer.

4. The signboard according to claim 2, wherein a recess and a protrusion that are engaged with each other are formed on opposing surfaces of the first sheet-form rubber magnet layer and the second sheet-form rubber magnet layer.
